(19) United States
(12) Patent Application Publication
(10) Pub. No.: US 2007/0221745 A1
(43) Pub. Date: Sep. 27, 2007

(54) Injection Nozzle

(76) Inventors: Wolfgang Stoecklein, Stuttgart (DE); Holger Rapp, Ditzingen (DE); Thomas Schwarz, Schorndorf (DE); Andreas Gruenberger, Spraitbach (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/593,865

(22) PCT Filed: Feb. 1, 2005
(86) PCT No.: PCT/EP05/50436

§ 371 Date: Sep. 22, 2006

(30) Foreign Application Priority Data
Apr. 8, 2004 (DE) 10 2004 017 303.6

(51) Int. Cl. F02M 61/18

(52) U.S. Cl. 239/88

(57) ABSTRACT

The invention relates to an injection nozzle for an internal combustion engine having a nozzle needle or needle unit for controlling an injection of fuel through at least one injection orifice and an actuator for driving a coupling piston. The nozzle needle or needle unit has a control surface that at least partially delimits a control chamber which communicates with a coupling chamber that is at least partially delimited by the coupling piston. The control surface is situated at the end of the nozzle needle or nozzle unit oriented away from the at least one injection orifice and the actuator drives the coupling piston to open the nozzle needle in such a way that a volume of the coupling chamber increases.

### PRIOR ART

The invention relates to an injection nozzle for an internal combustion engine, in particular in a motor vehicle, with the defining characteristics of the preamble to claim 1.

U.S. Pat. No. 6,520,423 B1 has disclosed an injection nozzle of this kind that has a nozzle needle for controlling an injection of fuel through at least one injection orifice. The injection nozzle also has a piezoelectric actuator for driving a coupling piston that protrudes into a coupling chamber and at least partially delimits it. The nozzle needle or a needle unit that contains the nozzle needle has a control surface that at least partially delimits a control chamber and communicates with the coupling chamber. In the known injection nozzle, the control surface is situated at an end of the nozzle needle or needle unit oriented toward the at least one injection orifice. In order to open the nozzle needle, the actuator in the known injection nozzle drives the coupling piston so that it plunges deeper into the coupling chamber, thus reducing the volume of the coupling chamber. The reduction in the coupling chamber volume increases the pressure contained therein, which causes a corresponding pressure increase in the control chamber with which it communicates. Correspondingly, the control surface in the control chamber is subjected to the increased pressure, which exerts a force on the nozzle needle or needle unit, oriented away from the at least one injection orifice. As a result, the opening forces acting on the nozzle needle or needle unit prevail so that the nozzle needle lifts away from its seat and permits a fuel injection to occur through the at least one injection orifice.

In the known injection nozzle, the nozzle needle is therefore controlled with the aid of an excess pressure that can be significantly higher than the pressure usually present in the coupling chamber and the control chamber. When the nozzle needle is closed, usually a relatively high injection pressure is present in both the coupling chamber and the control chamber, which makes it necessary to maintain relatively strict manufacturing tolerances in order to avoid undesirably high leakages. Strict manufacturing tolerances, however, are accompanied by comparatively high manufacturing costs. Furthermore, in the known injection nozzle, the control surface is embodied on a control piston, which drives the nozzle needle and is a component of the needle unit. Depending on the exertion of pressure on the control chamber and the control surface, more or less pronounced lateral forces can impinge on the control piston and be transmitted to the nozzle needle due to the coupling between them. This can lead to an increased friction between the nozzle needle and its needle guide, which can impair proper function of the nozzle needle.

### ADVANTAGES OF THE INVENTION

The injection nozzle according to present invention, with the defining characteristics of claim 1, has the advantage over the prior art that the nozzle needle can be controlled directly by means of a vacuum, which essentially permits less strict manufacturing tolerances to be set. An increased amount of guidance play has the inverse effect of reducing manufacturing costs. Furthermore, in the injection nozzle according to the invention, the increase or reduction of pressure against the control surface can be easily implemented so that no lateral forces are introduced into the nozzle needle or needle unit, which improves the function of the injection nozzle.

According to an advantageous embodiment form, the coupling piston can at least partially delimit the coupling chamber on a side closer to the at least one injection orifice. The result of this embodiment is that the actuator drives the coupling piston toward the at least one injection orifice, which permits a particularly compact design of the injection nozzle.

In another advantageous embodiment form, the coupling piston is supported so that it can execute a stroke motion in a cylindrical chamber contained in an insert piece that is situated axially between the actuator and the nozzle needle or needle unit. An insert piece of this kind can easily be manufactured with the required degree of precision, which reduces the manufacturing costs for the injection nozzle.

In one modification, the cylindrical chamber can contain a return spring, which rests against the coupling piston at one end and rests against a bottom of the cylindrical chamber at the other. To assist the closing of the nozzle needle, a return spring of this kind can prestress the coupling piston into its starting position with a definite return force, which simultaneously results in a definite pressure increase in the coupling chamber and consequently in the control chamber. This makes it possible to increase the effective forces acting on the nozzle needle in the closing direction. The proposed return spring thus assists the closing motion of the nozzle needle.

Other important defining characteristics and advantages of the injection nozzle according to the invention ensue from the dependent claims, the drawings, and the accompanying description of the figures in the drawings.

### DRAWINGS

An exemplary embodiment of the injection nozzle according to the invention is shown in the drawings and will be explained in detail below; components that are the same, similar, or functionally equivalent have been provided with the same reference numerals.

FIG. 1 schematically depicts a longitudinal section through an injection nozzle according to the invention,

FIG. 2 is a schematically depicted, enlarged detail view of a longitudinal section through the injection nozzle labeled II in FIG. 1.

### DESCRIPTION OF THE EXEMPLARY EMBODIMENT

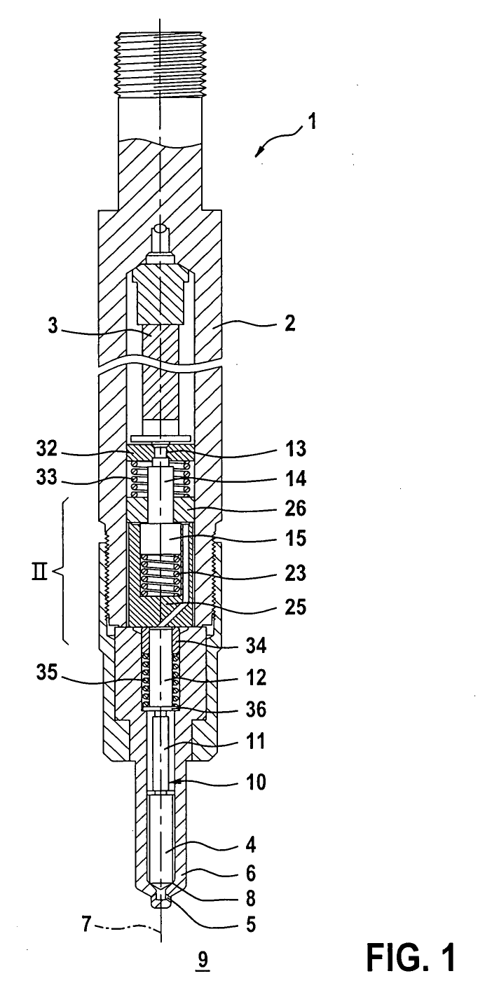

According to FIG. 1, an injection nozzle 1 according to the invention includes a nozzle body 2 that contains an actuator 3 and a nozzle needle 4. The actuator 3 is preferably embodied as a piezoelectric actuator 3, i.e. a piezoactuator 3, whose axial length increases when acted on with current and decreases again when the current is switched off. The nozzle needle 4 is used to control an injection of fuel through at least one injection orifice 5 situated in a nozzle tip 6. Usually, the injection nozzle 1 has a number of injection orifices 5, which can be arranged in an approximate star shape in relation to a longitudinal central axis 7 of the nozzle needle 4 and the injection nozzle 1. The nozzle needle 4 cooperates with a needle seat 8. When the nozzle needle 4 is in the closed state, it rests against its needle seat 8 and disconnects the at least one injection orifice 5 from a fuel supply, not shown in detail, in which the fuel to be injected is kept in readiness at a relatively high injection pressure. In the open state, the nozzle needle 4 is lifted away from the needle seat 8, which connects the at least one injection orifice 5 to the fuel supply. This results in an injection of fuel into an injection chamber 9, which can be a combustion chamber or a mixture formation chamber.

The injection nozzle 1 is used to inject fuel into the combustion chamber of a cylinder of an internal combustion engine, which can in particular be contained in a motor vehicle. Each cylinder of the engine is associated with a separate injection nozzle 1. In the so-called “common rail system”, a single fuel supply is provided for all of the injection nozzles 1 of the engine and keeps the fuel to be injected in readiness at the relatively high level of the injection pressure.

The nozzle needle 4 here is a component of a needle unit 10, which in the example here can include a coupling rod 11 and a control piston 12 in addition to the nozzle needle 4. The individual components of the needle unit 10 comprise a unit that can execute a stroke motion as a whole and is suitable at least for transmitting compressive forces. It is fundamentally possible for two adjacent components of the needle unit 10 to rest loosely against each other. It is also possible for two adjacent components of the needle unit 10 to be attached to each other, e.g. by means of a welded or soldered connection. It is likewise possible for at least two components of the needle unit 10 to be integrally manufactured out of a single piece.

By means of a joint-like coupler 13, the actuator 3 drives a piston rod 14 and, by means of this rod, a coupling piston 15.

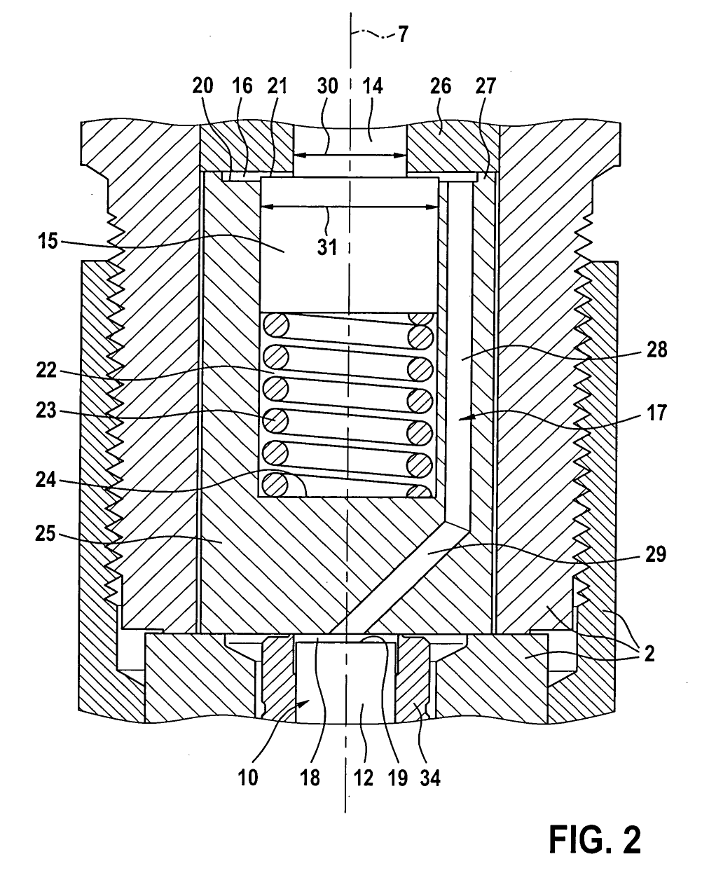

According to FIG. 2, the coupling piston 15 at least partially delimits a coupling chamber 16. This coupling chamber 16 communicates with a control chamber 18 via a connecting path 17. This control chamber 18 is at least partially delimited by the control piston 12 and/or by a control surface 19. The control surface 19 here is situated on the control piston 12. It is also possible for the control surface 19 to be situated directly on the nozzle needle 4 or another component of the needle unit 10.

According to the present invention, the control surface 19 is situated on the nozzle needle 4 or needle unit 10 so that it is oriented away from the at least one injection orifice 5. This means that a pressure prevailing in the control chamber 18 acts on the control surface 19 so that it can exert a force that acts on the nozzle needle 4 or needle unit 10 in the closing direction of the nozzle needle 4. In addition, the situation of the coupling piston 15 in relation to the coupling chamber 16 in the present invention is selected so that the actuator 3, when actuated to open the nozzle needle 4, drives the coupling piston 15 in such a way that a volume of the coupling chamber 16 increases.

In the embodiment form shown here, the coupling piston 15 at least partially delimits the coupling chamber 16 on a side 20 closer to the at least one injection orifice 5. As a result, the coupling piston 15 has a coupling surface 21 facing away from the at least one injection orifice 5, which surface is situated in the coupling chamber 16 and partially delimits it. In order to increase the volume in the coupling chamber 16, therefore, the actuator 3 drives the coupling piston 15 in the direction toward the at least one injection orifice 5.

In the preferred embodiment form shown here, the coupling piston 15 is supported so that it can execute a stroke motion in a cylindrical chamber 22. This cylindrical chamber 22 contains a return spring 23 that is also referred to below as the coupling piston return spring 23. In the axial direction, one end of the coupling piston return spring 23 rests against the coupling piston 15 and the other end rests against a bottom 24 of the cylindrical chamber 22. The cylindrical chamber 22 is also connected in a manner not shown in detail here to a leakage system so that a stroke motion of the coupling piston 15 can change the volume in the cylindrical chamber 22 without this causing a significant pressure change in the cylindrical chamber 22.

The cylindrical chamber 22 is contained in an insert piece 25 embodied as a separate component, which is situated axially between the actuator 3 and the nozzle needle 4 or needle unit 10. The insert piece 25 in the embodiment form shown here thus rests in the axial direction against a component of the nozzle body 2 at one end and against a sealing plate 26, for example, at the other. In the embodiment form shown here, the insert piece 25, at an end oriented toward the actuator 3, has an axially protruding annular collar 27 on its radial outside, which is supported axially against the sealing plate 26, thus forming the coupling chamber 16 situated axially between the sealing plate 26 and the insert piece 25. In addition, in the embodiment form shown here, the connecting path 17 is integrated into the insert piece 25. For example, the connecting path 17 can be comprised of two bores 28 and 29 that communicate with each other, one 28 of which is connected to the coupling chamber 16 and the other 29 of which is connected to the control chamber 18.

In the embodiment form shown here, the piston rod 14 passes centrally through the sealing plate 26 and is supported axially against the coupling piston 15. Here, too, it is basically possible for the piston rod 14 and the coupling piston 15 to simply rest loosely against each other. It is also possible for the coupling piston 15 and the piston rod 14 to be attached to each other or to be integrally produced out of a single piece. The piston rod 14 protrudes into the coupling chamber 16, i.e. the piston rod 14 passes through the coupling chamber 16 in the axial direction until reaching the coupling piston 15. At least in the region inside the coupling chamber 16, the piston rod 14 here has an outer cross-section 30 that is smaller than an outer cross-section 31 of the coupling piston 15. This produces the coupling surface 21, which makes the coupling chamber volume dependent on the stroke position of the coupling piston 15 and piston rod 14. In the current case, the piston rod 14 and/or the coupling piston 15 is/are cylindrical, in particular circular and cylindrical.

According to FIG. 1, an additional return spring 33, which is also referred to below as the actuator return spring 33, can be provided between the sealing plate 26 and a support plate 32 supported axially on the actuator 3. In the axial direction, the actuator return spring 33 rests against the support plate 32 at one end and against the sealing plate 26 at the other and is consequently supported against the nozzle body 2 via the insert piece 25. The coupler 13 passes centrally through the support plate 32, connecting the actuator 3 to the piston rod 14.

According to FIG. 2, the control chamber 18 is situated axially between the insert piece 25 and the control piston 12; in this case, it is also radially encompassed by a sleeve 34. The control piston 12 is supported so that it can execute a stroke motion inside this sleeve 34. It is clear from FIG. 2 here, that the routing of the connecting path 17 inside the insert piece 25 can be advantageously embodied specifically so that the connecting path 17 feeds centrally into the control chamber 18 via the bore 29. This makes it possible to achieve a particularly uniform pressure increases and decreases in the control chamber 18 in order to avoid exerting lateral forces on the control piston 12 and therefore on the needle unit 10.

Referring to FIG. 1 once again, it is possible to provide an additional return spring 35 that is also referred to below as a needle return spring 35. The needle return spring 35 rests in the axial direction against the sleeve 34 at one end and against a support ring 36 on the other, which in turn rests against the needle unit 10 or a component of the needle unit 10.

The injection nozzle 1 according to the present invention functions as follows:

In an initial state, the nozzle needle 4 is closed, i.e. the nozzle needle 4 rests against the needle seat 8, thus closing off the connection of the fuel supply to the at least one injection orifice 5. In this initial state, the same pressure, in particular the high fuel pressure, prevails in the control chamber 18 and in the coupling chamber 16. For example, this high fuel pressure can be adjusted in relation to the fuel supply by means of an intentional and/or inevitable leakage of the coupling chamber 16 and/or the control chamber 18 and/or the connecting path 17. The effective pressure in the control chamber 18 acts on the control surface 19 with a force oriented in the closing direction of the nozzle needle 4. The needle return spring 35 also exerts a closing force on the needle unit 10. On the whole, the effective forces on the needle unit 10 in the closing direction prevail.

The actuator return spring 33 prestresses the actuator 3 in the direction of its shortened starting position. The coupling piston return spring 23 prestresses the coupling piston 15 in opposition to the force acting in the coupling chamber 16.

In order to initiate an injection through the at least one injection orifice 5, the actuator 3 is actuated or activated, which causes it to elongate, thus driving the coupling piston 15 via the piston rod 14 axially in the direction of the at least one injection orifice 5. This causes the coupling surface 21 of the coupling piston 15 that is exposed to the coupling chamber 16 to move in relation to the coupling chamber 16, thus enlarging the volume of the coupling chamber 16. As the volume of the coupling chamber increases, a pressure drop occurs in the coupling chamber 16, which spreads to the control chamber 18 via the connecting path 17. The reduced pressure in the control chamber 18 reduces the forces acting on the control surface 19 in the closing direction so that the effective forces acting on the needle unit 10 in the opening direction then prevail. As a result, the nozzle needle 4 lifts away from the needle seat 8, thus connecting the at least one injection orifice 5 to the fuel supply and permitting the injection to begin.

To terminate the injection, the actuator 3 is deactivated, which causes it to retract in length. Now that the actuator 3 is deactivated, the restoring forces of the return springs 23, 33, and 35, which were placed under stress by the opening process, can come into play and as a result, push the actuator, the coupling piston 15, and the nozzle needle 4 back into their initial positions. For the closing process of the nozzle needle 4, it is important that the coupling piston 15, driven by the coupling piston return spring 23, reduces the volume of the coupling chamber 16 again, which is accompanied by a corresponding pressure increase in the coupling chamber 16 and therefore also in the control chamber 18. The increased pressure in the control chamber 18 correspondingly increases the closing forces exerted on the needle unit 10 by means of the control surface 19. As soon as the nozzle needle 4 travels back into its needle seat 8, the connection of the at least one injection orifice 5 to the fuel supply is closed and the injection is terminated.

The injection nozzle 1 according to the invention is consequently directly controlled via the pressure or vacuum acting on the control service 19, which can be varied with the aid of the actuator 3. It is worth noting here that the hydraulically functioning components of the injection nozzle 1 are at the most, subjected to the injection pressure since the pressure in the control chamber 18 is reduced in order to actuate the nozzle needle 4. As a result, the hydraulic components can be produced at a lower cost from a production-engineering standpoint. In particular, less play and greater tolerances are permissible, which has an advantageous impact on manufacturing costs. Furthermore, there is no direct coupling between the nozzle needle 4 or needle unit 10 on the one hand and the coupling piston 15 on the other, which reduces or eliminates disadvantageous interactions between the components mentioned.

### REFERENCE NUMERAL LIST

1 injection nozzle
2 nozzle body
3 actuator
4 nozzle needle
5 injection orifice
6 nozzle tip
7 longitudinal central axis of nozzle
8 needle seat
9 injection chamber
10 needle unit
11 coupling rod
12 control piston
13 coupler
14 piston rod
15 coupling piston
16 coupling chamber
17 connecting path
18 control chamber
19 control surface
20 side of 16
21 coupling surface
22 cylinder chamber
23 return spring
24 bottom of 22
25 insert piece
26 sealing plate
27 annular collar
28 bore
29 bore
30 outer cross-section of 16
31 outer cross-section of 15
32 support plate
33 return spring
34 sleeve
35 return spring
36 support ring

1-9. (canceled)

10. An injection nozzle for an internal combustion engine, in particular in a motor vehicle, comprising
a nozzle needle or a needle unit including a nozzle needle for controlling an injection of fuel through at least one injection orifice
an actuator for driving a coupling piston,
the nozzle needle or needle unit having a control surface that at least partially delimits a control chamber,
means providing communication between the control chamber and a coupling chamber at least partially delimited by the coupling chamber
the control surface being situated at the end of the nozzle needle or nozzle unit oriented away from the at least one injection orifice, and
the actuator driving the coupling piston to open the nozzle needle in such a way that a volume of the coupling chamber increases.

11. The injection nozzle according to claim 10, wherein the coupling piston at least partially delimits the coupling chamber on a side closer to the at least one injection orifice.

12. The injection nozzle according to claim 10, wherein the coupling piston is supported so that it can execute a stroke motion in a cylindrical chamber, and wherein
the cylindrical chamber is contained in an insert piece that is situated axially between the actuator and the nozzle needle or needle unit.

13. The injection nozzle according to claim 11, wherein the coupling piston is supported so that it can execute a stroke motion in a cylindrical chamber, and wherein
the cylindrical chamber is contained in an insert piece that is situated axially between the actuator and the nozzle needle or needle unit.

14. The injection nozzle according to claim 12, further comprising a return spring contained in the cylindrical chamber and resting against the coupling piston at one end and against a bottom of the cylindrical chamber at the other.

15. The injection nozzle according to claim 13, further comprising a return spring contained in the cylindrical chamber and resting against the coupling piston at one end and against a bottom of the cylindrical chamber at the other.

16. The injection nozzle according to claim 12, further comprising a connecting path contained in the insert piece and connecting the control chamber to the coupling chamber.

17. The injection nozzle according to claim 13, further comprising a connecting path contained in the insert piece and connecting the control chamber to the coupling chamber.

18. The injection nozzle according to claim 14, further comprising a connecting path contained in the insert piece and connecting the control chamber to the coupling chamber.

19. The injection nozzle according to claim 15, further comprising a connecting path contained in the insert piece and connecting the control chamber to the coupling chamber.

20. The injection nozzle according to claim 10, wherein the actuator drives the coupling piston via a piston rod, which passes through the coupling chamber until reaching the coupling piston and whose outer cross-section exposed to the coupling chamber is smaller than the outer cross-section of the coupling piston exposed to the coupling chamber.

21. The injection nozzle according to claim 11, wherein the actuator drives the coupling piston via a piston rod, which passes through the coupling chamber until reaching the coupling piston and whose outer cross-section exposed to the coupling chamber is smaller than the outer cross-section of the coupling piston exposed to the coupling chamber.

22. The injection nozzle according to claim 12, wherein the actuator drives the coupling piston via a piston rod, which passes through the coupling chamber until reaching the coupling piston and whose outer cross-section exposed to the coupling chamber is smaller than the outer cross-section of the coupling piston exposed to the coupling chamber.

23. The injection nozzle according to claim 14, wherein the actuator drives the coupling piston via a piston rod, which passes through the coupling chamber until reaching the coupling piston and whose outer cross-section exposed to the coupling chamber is smaller than the outer cross-section of the coupling piston exposed to the coupling chamber.

24. The injection nozzle according to claim 16, wherein the actuator drives the coupling piston via a piston rod, which passes through the coupling chamber until reaching the coupling piston and whose outer cross-section exposed to the coupling chamber is smaller than the outer cross-section of the coupling piston exposed to the coupling chamber.

25. The injection nozzle according to claim 12, wherein the actuator drives the coupling piston via a piston rod, which passes through the coupling chamber until reaching the coupling piston and whose outer cross-section exposed to the coupling chamber is smaller than the outer cross-section of the coupling piston exposed to the coupling chamber, and wherein the coupling chamber is situated axially between the insert piece and a sealing plate through which the piston rod centrally passes.

26. The injection nozzle according to claim 25, wherein the sealing plate rests axially against the insert piece and/or an additional return spring rests against the sealing plate and also rests directly or indirectly against the actuator.

27. The injection nozzle according to claim 10, further comprising a connecting path connecting the control chamber to the coupling chamber, the connecting path being axially and centrally connected to the control chamber.

28. The injection nozzle according to claim 11, further comprising a connecting path connecting the control chamber to the coupling chamber, the connecting path being axially and centrally connected to the control chamber.

29. The injection nozzle according to claim 12, further comprising a connecting path connecting the control chamber to the coupling chamber, the connecting path being axially and centrally connected to the control chamber.
